(19) United States
(12) Patent Application Publication
(10) Pub. No.: US 2005/0163155 A1
(43) Pub. Date: Jul. 28, 2005

(54) Method for wireless local area network communication for adaptive piggyback decision

(75) Inventors: Chil-youl Yang, Yongin-si (KR); Chang-yeul Kwon, Seongnam-si (KR); Tae-kon Kim, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/023,169

(22) Filed: Dec. 28, 2004

(30) Foreign Application Priority Data
Jan. 26, 2004 (KR) 10-2004-0004695

(51) Int. Cl. H04J 3/22; H04J 3/16; H04Q 7/00; H04J 3/24; H04H 1/00

(52) U.S. Cl. 370/465; 370/329

(57) ABSTRACT

A wireless local area network (LAN) communication method that includes adaptively determining whether to apply a piggyback according to a communication environment, and transmitting a frame containing two or more kinds of information according to the result of the determination.

This application claims priority of Korean Patent Application No. 10-2004-0004695 filed on Jan. 26, 2004 in the Korean Intellectual Property Office, the disclosure of which is incorporated herein in its entirety by reference.

### BACKGROUND OF THE INVENTION

1. Field of the Invention

The present invention relates to a wireless local area network (LAN) communication method, and more particularly, to a wireless LAN communication method capable of adaptively selecting a communication method according to the communication environment.

2. Description of the Related Art

In general, a wireless LAN is a short-distance wireless network in compliance with an IEEE 802.11 standard. Wireless LAN standards currently approved or still under development include: 802.11b, which provides a data transfer rate of up to 11 megabits per second (Mbps) in the 2.4 gigahertz (GHz) frequency band using Frequency Hopping Spread Spectrum (FHSS), Direct Sequence Spread Spectrum (DSSS), or Infrared Rays (IR); 802.11a, which operates in the 5 GHz frequency band and delivers a data transfer rate of up to 54 Mbps based on an Orthogonal Frequency Division Multiplexing (OFDM) scheme; 802.11e, which is proposed to improve Quality of Service (QoS); 802.11f, which is designed for an Inter-Access Point Protocol (IAPP), 802.11g that operates in the 2.4 GHz frequency band and offers a data transfer rate of up to 54 Mbps using an OFDM scheme; 802.11h, which provides Transmit Power Control (TPC) and Dynamic Frequency Selection (DFS) mechanisms; and 802.11i, which beefs up security. In addition, an 802.11 Study Group (5 GHz Globalization Special Group; 5GSG) has been formed to address harmonization of the 5 GHz frequency range, and a 902.11 Wireless LAN Next Generation (WNG) standing committee is developing next-generation wireless LAN technology.

Wireless LANs generally use the 2.4-2.5 GHz or 5 GHz Industrial/Scientific/Medial (ISM) bands authorized for wireless LAN applications. The ISM bands are frequency bands designated for use by industrial, scientific, or medical equipment, and can be used without permission where the emitted power is below a predetermined level.

The IEEE 802.11 network is built around a Basic Service Set (BSS), which is a group of stations communicating with one another. There are two specific kinds of BSS's: an independent BSS (IBSS) where stations directly communicate with one another without an access point (AP), and an infrastructure BSS where an AP is used for all communication.

FIG. 1 shows a typical configuration of a wireless LAN. As shown in FIG. 1, the wireless LAN allows stations within a predetermined distance of one another to wirelessly send and receive data to and from one another without the need for floor wiring similar to that of wired Ethernet. Thus, within the wireless LAN, stations wirelessly communicate with one another so they are free to move from place to place. As depicted in FIG. 1, infrastructure BSS's may be combined with each other to form an Extended Service Set (ESS). All stations within the infrastructure BSS must communicate with one another through an AP. For example, when a first station wishes to send a frame to a second station, the frame is sent first to the AP, and then the AP delivers the frame to the second station. Upon receipt of the frame, the second station transmits an Ack frame confirming the receipt of the frame to the first station through the AP. Thus, in the infrastructure BSS, frame exchanges take two hops.

FIG. 2 shows Media Access Control (MAC) architecture compliant with an IEEE 802.11 standard specification.

Referring to FIG. 2, a communication scheme in the infrastructure BSS is mainly divided into two modes: Distributed Coordination Function (DCF) and Point Coordination Function (PCF). The PCF mode allows a special station called a Point Coordinator (PC), which an AP mainly acts as, to transfer data between stations without contention to media.

In the IBSS, an access to wireless media occurs in DCF mode. The DCF mode is based on Carrier Sense Multiple Access with Collision Avoidance (CSMA/CA) for high transmission efficiency unlike the wired Ethernet which uses Carrier Sense Multiple Access with Collision Detection (CSMA/CD). According to the CSMA/CA mechanism, first, a check is made to see if a channel is idle, and if the channel is idle, data transfer occurs. Meanwhile, the 802.11 DCF protocol adopts a scheme in which a sender transmits a frame after waiting a random back-off time, even if the channel is idle, in order to avoid frame collision between stations together with CSMA/CA.

According to the IEEE 802.11 standard specification, a single frame combining a plurality of information can be transmitted in the PCF mode. For example, the frame may carry data+acknowledgement (ACK), data+poll, data+ACK+poll, or ACK+poll for transmission.

Although the IEEE 802.11 standard specification defines the type of data frame using piggyback so as to transmit a frame combining a plurality of information types, it does not define a mechanism for determining when to apply piggyback. Actually, using piggyback may either enhance or degrade communications efficiency, depending on the status of a transfer medium or the size of data to be transferred, compared to when the piggyback method is not used.

### SUMMARY OF THE INVENTION

The present invention provides a method for adaptively determining whether to apply a piggyback method for wireless LAN communications and a wireless LAN communication method employing the same.

According to an aspect of the present invention, there is provided a wireless LAN communication method comprising adaptively determining whether to apply a piggyback according to a communication environment and transmitting a frame containing two or more kinds of information according to the result of the determination.

The determination of whether or not to apply the piggyback may be based on information about a target station to which a frame is to be sent. Here, the information about the target station may contain information about whether the frame is successively sent to the same station.

The determination of whether or not to apply the piggyback may be based on information about characteristics of data to be transmitted. Here, the information about the characteristics of data to be transmitted may contain information about whether the size of a frame is less than a predetermined threshold.

Also, the determining of whether or not to apply the piggyback may be based on information about channel status, and the information about channel status may contain information about whether a frame loss rate is less than a predetermined threshold or information about whether a derived received signal strength indication (RSSI) is greater than a predetermined threshold.

In the step of transmitting, the type of frame carrying two or more kinds of information may be one of data+poll, data+ACK, data+poll+ACK, and poll+ACK frames.

In the wireless LAN communication method, frame transfer is carried out in a Point Coordination Function (PCF) mode.

According to another aspect of the present invention, there is provided a recording medium on which is recorded a program that performs one of the above-described wireless LAN communication methods.

### BRIEF DESCRIPTION OF THE DRAWINGS

The above and other features and advantages of the present invention will become more apparent by describing in detail exemplary embodiments thereof with reference to the attached drawings in which:

FIG. 1 depicts the general configuration of a wireless local area network;

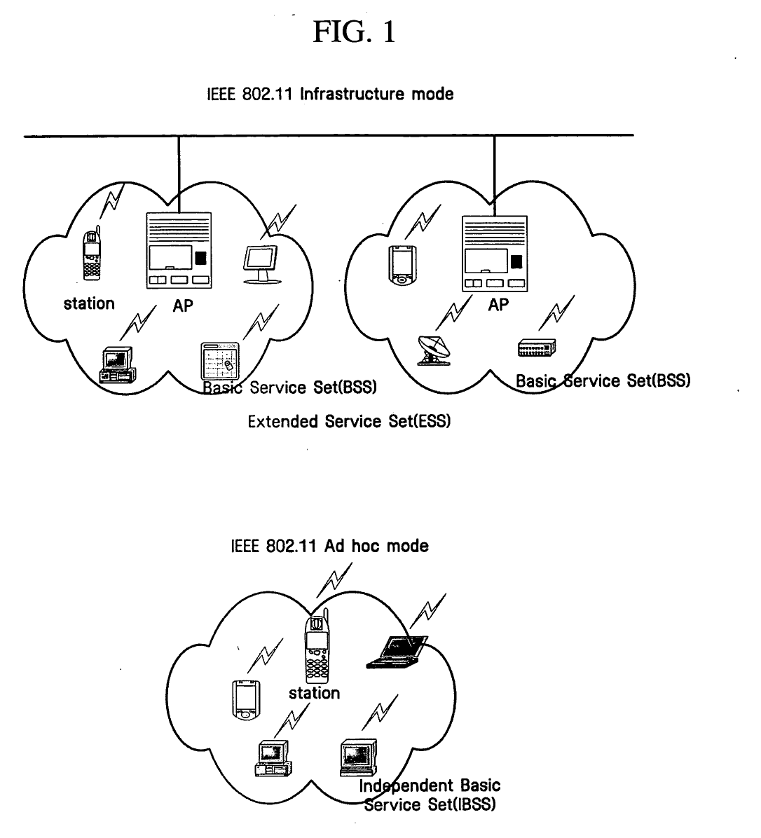

FIG. 2 depicts the architecture of Medium Access Control (MAC) according to an IEEE 802.11 standard specification;

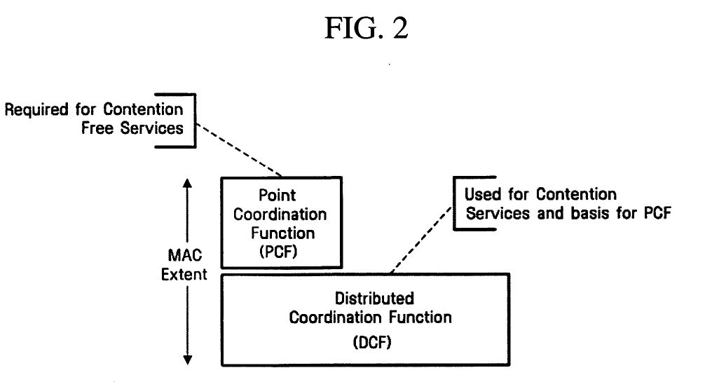

FIG. 3 shows an example of operations of an access point (AP) and stations in a Point Coordination Function (PCF) mode according to the IEEE 802.11 standard specification;

FIG. 4 is a flowchart showing a process for determining whether to apply a piggyback between an AP and stations in a PCF mode according to an exemplary embodiment of the present invention;

FIG. 5 shows a general frame format according to the IEEE 802.11 standard specification;

FIG. 6 is a table showing combinations of the type and subtype values of a frame that can be used according to the IEEE 802.11 standard specification;

FIG. 7 shows the result of a simulation when piggyback is applied in a PCF mode in a good communication environment; and

FIG. 8 shows the result of a simulation when piggyback is applied in a PCF mode in a poor communication environment.

### DETAILED DESCRIPTION OF THE INVENTION

The present invention will now be described more fully with reference to the accompanying drawings, in which exemplary embodiments of the invention are shown.

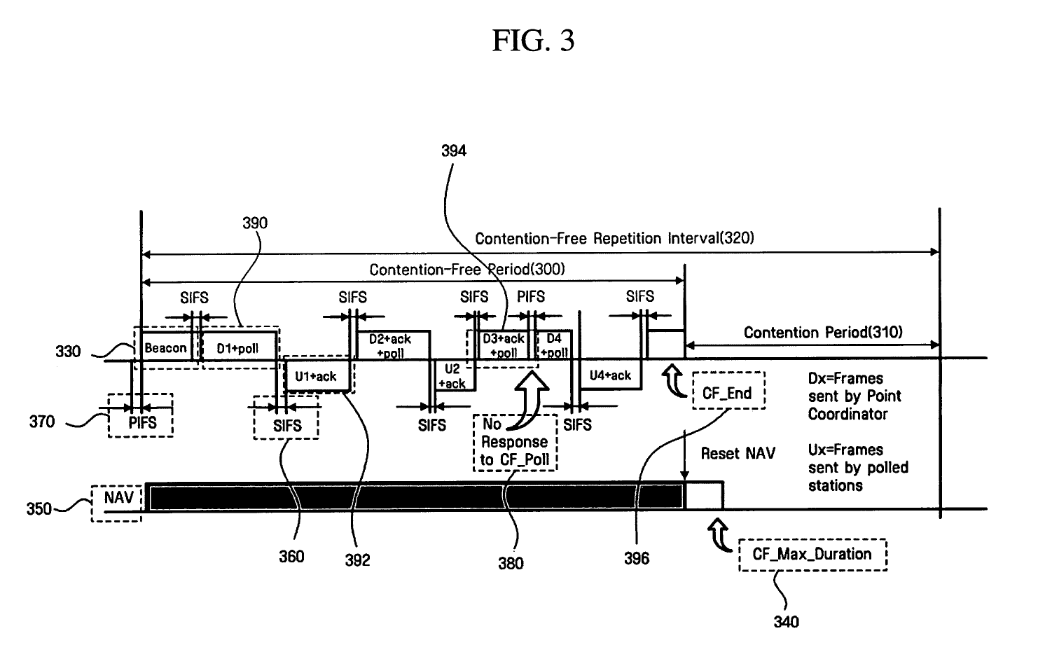

FIG. 3 shows an example of operations of an access point (AP) and stations in a Point Coordination Function (PCF) mode according to the IEEE 802.11 standard specification.

The standard specification defines a PCF that is used for contention free transfer as a method of accessing a wireless medium. The contention free services may be provided over the entire time, but in most cases a contention free period (CFP) 300 of a contention free service arbitrated by a Point Coordinator (PC) alternates with Distributed Coordination Function (DCF)-based services. Since the PC restricts access to the medium, which is a special function supplied to the AP, the associated stations can transfer data only with the permission of the PC.

In FIG. 3, the time axis on the medium is divided into a CFP 300 and a Contention Period (CP) 310. Access to the medium in a CFP 300 and a CP 310 is controlled by the PCF and the DCF, respectively. Alternation between contention free and contention-based services repeats at regular intervals called a Contention Free Repetition Interval 320.

At the beginning of the CFP 300, the AP transmits a Beacon frame 330. The Beacon frame 330, carrying parameters to be referenced by a station when participating in a network, is periodically sent so that the station finds and identifies a particular network. In an infrastructure network, the AP is responsible for sending the Beacon frame 330. One element of the beacon frame is CFP_Max_Duration 340, which is the maximum duration time of a CFP. All stations that receive the beacon set the network allocation vector (NAV) 350 to the CFP_Max_Duration 340 in order to lock out a DCF-based access to a wireless medium. The NAV 350 is used to implement a virtual carrier sense function, and most frames contain a non-zero value in their NAV fields. Specifically, the virtual carrier sense function is used to request that the medium be reserved for a specified number of microseconds following the transmission of the current frame. The contention free transmission is separated into Short Interframe Space (SIFS) 360 and PCF Interframe Space (PIFS) 370 as an additional measure to prevent interference. Since both the SIFS 360 and the PIFS 370 are shorter than an interval between DCF frames, no DCF-based station can gain access to the medium to use a DCF.

Once the AP has gained access to the wireless medium, it polls associated stations on a polling list for data transmission. During the CFP 300, a station is permitted to transmit only when receiving a poll frame from the AP. The polling list contains all stations that are permitted to send frames during the CFP 300. The stations can be on the polling list when they are associated with the AP. Association request includes a field indicating whether the station can respond to the CF-poll during the CFP 300.

Generally, all data transmissions are separated by the SIFS 360 during the CFP 300. If the PC fails to receive any response from the station after waiting for a PIFS interval, then the PC transmits the poll frame to the next station in the polling list so that the PC can maintain control over the medium. Since the AP in FIG. 3 sends the poll frame to a third station but fails to receive a response, the AP waits for one PIFS interval and continues to transmit the poll frame to a fourth station. Use of PIFS ensures that the AP maintains access to the medium.

During the CFP 300, the AP and stations are able to use various types of frames. Since time is an invaluable factor during the CFP 300, the AP and stations can combine acknowledgement (ACK), poll, and data frames into a single frame for transmission in order to improve the efficiency in transmission. By way of example, a single frame in combination with an ACK frame sent by a station to the station that has transmitted the previous frame, a poll frame polling the station on the polling list for transmission of buffered data, and a send frame sending its own data to the polled station, to produce a single combined frame. The following types of frames are used during the CFP 300. A standard data frame refers to a frame containing data to be transmitted. An ACK frame is sent by an AP or a station to acknowledge receipt of data. A poll frame is transmitted by the AP to grant a station on the polling list a license to transmit a single buffered frame. In this case, if there is a frame for the station, the AP uses Data+Poll (D1+poll) frame 390.

Data+ACK (U1+ack) frame 392 is a combination of ACK and data frames. While the data is transmitted to a receiver of the frame, the ACK is sent to the station that has transmitted the previous frame. This type of frame 392 can be sent by both AP and stations.

The D1+poll frame 390 is transmitted by the AP in the infrastructure network during the CFP 300 to transmit data to a station on the polling list and to authorize the polled station to transmit a frame waiting to be sent. Since the data in the frame body is directed toward the receivers of the poll, data transmission and polling are not separated by the two different receivers.

An ACK+Poll frame is used to acknowledge receipt of the last frame transmitted by a client of the AP and to request transmission of a buffered frame from the next station on the polling list. In this case, ACK is transmitted to all stations associated with the AP whereas the frame is sent to the next station on the polling list. During the CFP 300, only the AP uses this type of frame.

A Data+ACK+Poll (D3+ack+poll) frame 394 is used to transmit data, poll, and ACK frames combined in a single frame for maximum efficiency. The data and poll are transmitted to the same station, but the ACK is returned to the station that has transmitted the previous frame. The D3+ack+poll frame 394 is used by the AP in the infrastructure network during the CFP 300.

A CF-End (CF-End) frame 396 terminates the CFP 300 and returns the medium control to a contention-based DCF mechanism. The PC is able to suspend the contention free services before the end of CF_Max_Duration 340 using the CF-End frame 396. This decision can be made based on the size of a polling list, the amount of traffic, and other factors that the AP considers to be important. Although operations between the AP and stations described above have been performed in a PCF mode, which is one of the wireless LAN communication methods. The stations are also able to operate according to the same mechanism in wireless LAN communications using a DCF mode.

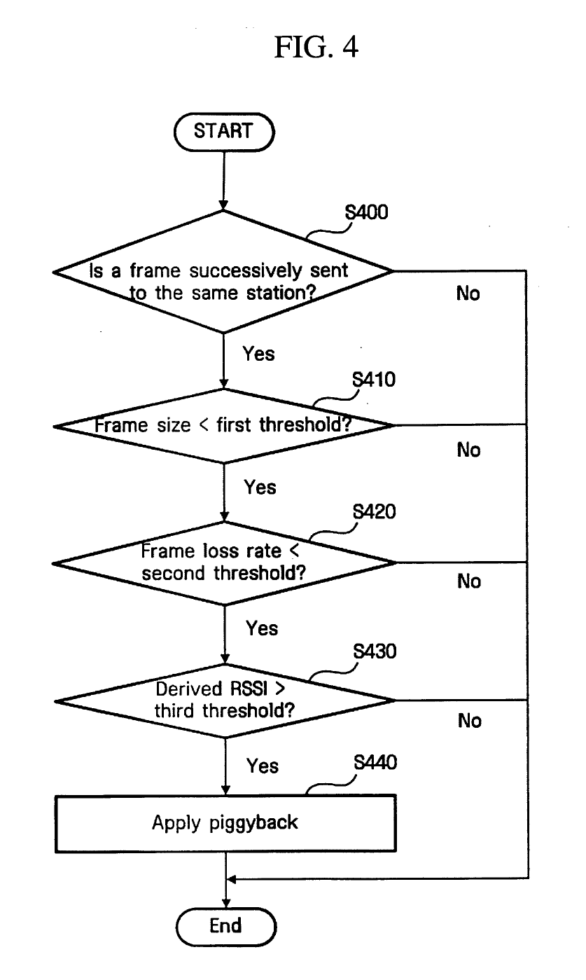

FIG. 4 is a flowchart showing a process for determining whether to apply a piggyback between an AP and stations in a PCF mode according to an exemplary embodiment of the invention.

To determine whether to apply a piggyback in the PCF mode, the AP and stations use information about a station to which a frame is to be sent. In this case, the AP and stations may use information that indicates whether to send a frame successively to the same station or that indicates how frequent collisions have been in the previous frame transfer to the target station. As shown in FIG. 4, in step S400, adaptive piggyback is determined based on whether to send a frame successively to the same station, as included in information about the target station. The process of determining whether to apply a piggyback ends when the frame is not successively sent to the same station.

Where the frame is successively sent to the same target station, the transmitting station uses information about characteristics of data to be transmitted in order to determine whether to apply a piggyback. In information on characteristics of data to be transmitted, FIG. 4 shows step S410 determining whether the size of a frame is less than a first threshold. If the size of the frame is greater than the first threshold, the process of determining whether to apply a piggyback terminates. This is because the probability of causing an error during transfer increases as the size of a frame increases, and occurrences of an error in frame transfer applying a piggyback may reduce a throughput.

Conversely, if the size of the frame is less than the first threshold, transmitting stations use information about channel status in order to determine whether to apply a piggyback. FIG. 4 also shows steps of determining whether to apply the piggyback by analyzing a frame loss rate and a derived received signal strength indication (RSSI) in the various channel status information. In step S420, it is determined whether a frame loss rate is less than a second threshold. If the frame loss rate is greater than the second threshold, the process of determining whether to apply a piggyback ends. This is because recovery from the loss of a frame requires a lot of time, which may reduce a throughput.

On the other hand, if the frame loss rate is less than the second threshold, the transmitting stations determine whether the derived RSSI is greater than a third threshold in step S430. If the derived RSSI is less than the third threshold, the process of determining whether to apply a piggyback ends.

Conversely, if the derived RSSI is greater than the third threshold, in step S440, the transmitting station sets type and subtype values of a frame control field for a frame to be transmitted in such a way as to apply a piggyback, and the process of determining whether to apply the piggyback terminates.

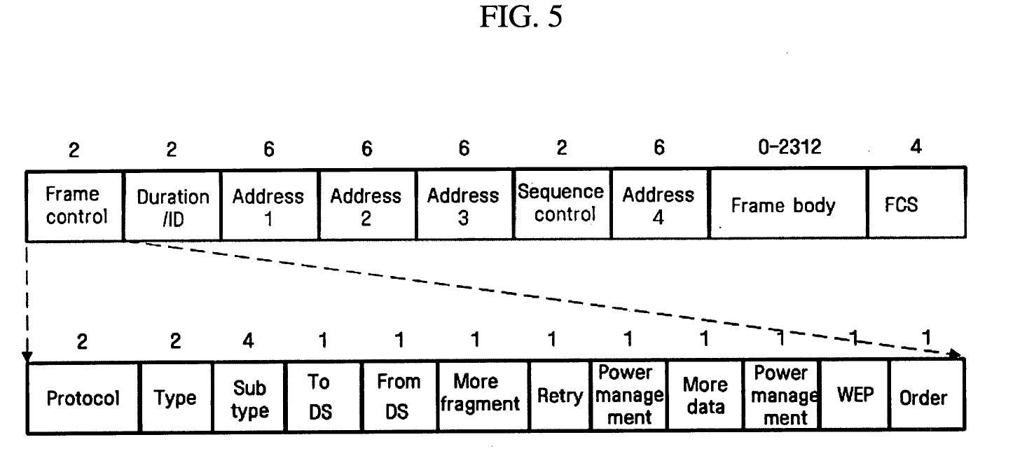

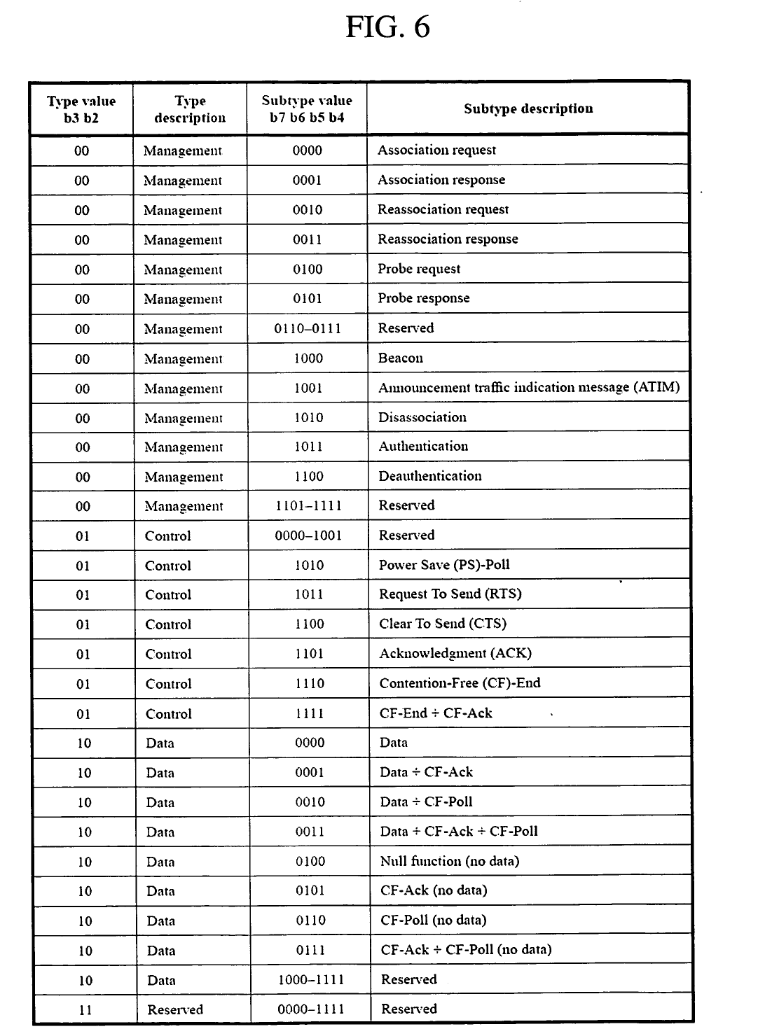

A general frame format and the type and subtype values of a frame that can be used according to the IEEE 802.11 standard specification will be described below with reference to FIGS. 5 and 6.

Since the thresholds may vary depending on the status of a communication environment, it is preferable to use experimentally obtained values.

The flowchart of FIG. 4 merely illustrates an exemplary embodiment of this invention. That is, it can be determined whether to apply a piggyback by considering whether various conditions are satisfied. The various conditions include the following: whether a frame is successively sent to the same target station, whether the size of a frame is less than the first threshold, whether the frame loss rate is less than the second threshold, and whether the derived RSSI is greater than the third threshold. That is, the piggyback can be applied when satisfying all of the conditions or at least one of the conditions or any possible combination of the conditions.

FIG. 5 shows a general frame format compliant with an IEEE 802.11 standard specification.

The order of transmission of octets of a frame is from left to right in FIG. 5, and a Most Significant Bit (MSB) appears last. The frame is comprised of a 2-byte frame control field, a 2-byte duration/ID, three 48-bit address fields(address 1, 2, and 3), a 2-byte sequence control, a 6-byte address field(address 4), a frame body (up to 2,312 bytes), and a 4-byte frame check sequence (FCS).

The frame control field consists of the following subfields: Protocol where a Protocol Version such as 802.11 MAC version is specified, Type and Subtype for differentiating the types of frames being used, “To DS” and “From DS” for storing various parameters for frame control, More Fragment, Retry, Power Management, More Data, Wired Equivalent Privacy (WEP), and Order. Combinations of frame type and frame subtype values that can be used according to an IEEE 802.11 standard specification will be described later with respect to FIG. 6.

The Duration/ID field is used for various purposes, including setting NAV (Network Allocation Vector) of frames transmitted during CFP, and setting the association identity (AID) of the station that transmitted the frame in control type frames of subtype Power Save (PS)-Poll.

Each address field is used to store parameters for moving a frame. The address 1 is used for a receiver, the address 2 is used for a sender, and the address 3 is used for filtering by the receiver.

The sequence control field is used to reassemble fragments and to discard all duplicate frames, and it consists of two subfields: a 4-bit fragment number and a 12-bit sequence number.

The frame body field called a data field may vary from zero to 2,312 bytes to include an 8-byte overhead which can transmit data up to 2,304 byte data. The FCS field is used to check the integrity of a frame received from a specific terminal.

FIG. 6 is a table showing combinations of the type and subtype values of a frame that can be used according to the IEEE 802.11 standard specification.

The type of a frame is mainly classified into management frame 00, control frame 01, and data frame 10. In addition, a reserved frame 11 may further exist. Each type of frame is differentiated by a 4-bit subtype field value. For example, a frame having a subtype value of 1000 in the management frame 00 is a beacon frame, one having a subtype value of 1101 in the control frame 01 is an ACK frame, and one having a subtype value of 0000 in the data frame 10 is a data frame. As depicted in FIG. 6, some subtypes are reserved for use in each type. The reserved type can be defined by a vendor who implements a wireless LAN product, or it can be used by improved MAC.

In the present invention, once application of a piggyback has been determined according to the process shown in the flowchart of FIG. 4, the transmitting station sets combinations of type and subtype values of a frame. In the case of applying a piggyback, a combination of type value 10 and one of the subtype values 0001, 0010, 0011, and 0111 can be used. That is, the combination is one of data+CF-Ack, data+CF-poll, data+CF-Ack+CF-Poll, and CF-Ack+CF-Poll. It is possible to create these combinations in a PCF mode. In a DCF mode, a reserved type can be used to define frame transfer applying a piggyback.

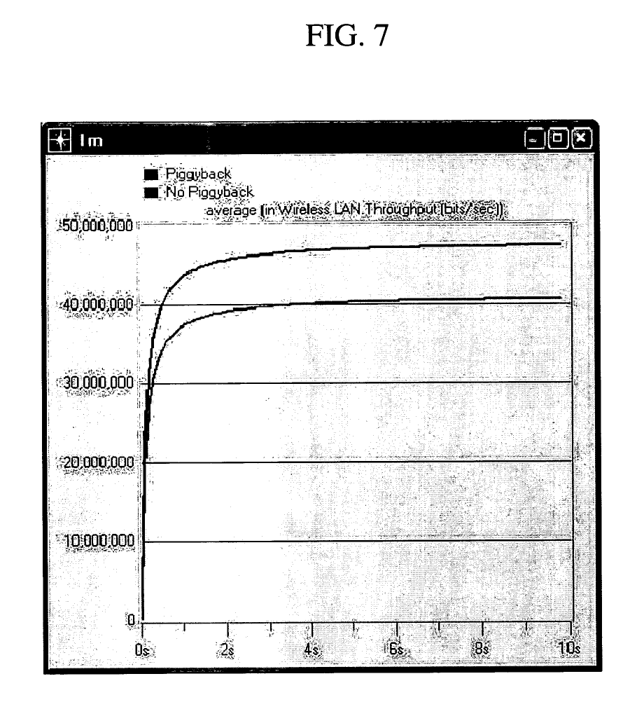

FIG. 7 shows the result of a simulation when piggyback is applied in a PCF mode in a good communication environment.

The good communication environment refers to the case where at least one of the following conditions described in the exemplary embodiment of the invention shown in FIG. 4 is satisfied: a frame is successively sent to the same target station, the size of a frame is less than the first threshold, the frame loss rate is less than the second threshold, and the derived RSSI is greater than the third threshold. Specifically, FIG. 7 shows the result of a simulation for throughput through comparison between a situation in which a piggyback is applied in a PCF mode and a situation in which no piggyback is applied in a good communication environment. As depicted in FIG. 7, since the transmission time under a good communication environment is reduced by the poll time plus SIFS and by SIFS plus ACK time, applying a piggyback offers a higher throughput than not applying the same.

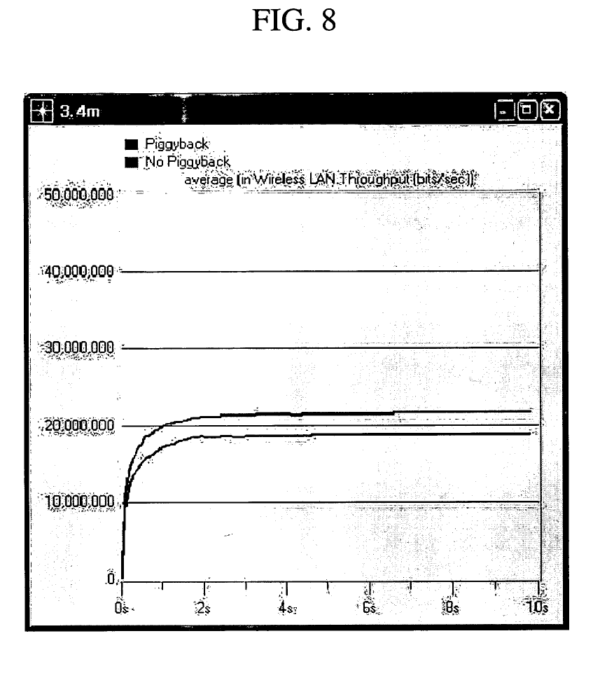

FIG. 8 shows the result of a simulation when piggyback is applied in a PCF mode in a poor communication environment. The poor communication environment refers to the case where none of the following conditions described in the embodiment of the invention shown in FIG. 4 is satisfied: a frame is successively sent to the same target station, the size of a frame is less than a first threshold, the frame loss rate is less than a second threshold, and the derived RSSI is greater than a third threshold. Specifically, FIG. 8 shows the result of a simulation for throughput through comparison between a situation in which a piggyback is applied in a PCF mode and a situation in which no piggyback is applied in a poor communication environment. As depicted in FIG. 8, applying a piggyback under a poor communication environment offers a lower throughput than not applying the same. Specifically, since the size of a data+ACK frame or a data+poll frame becomes greater than that of an ACK frame or a poll frame in a poor communication environment, the probability of causing a transmission failure increases when the piggyback is applied. Since the failure in frame transmission costs overhead due to a failure recovery, applying the piggyback provides lower throughput than not applying the same. Accordingly, it is highly desirable to have a mechanism for determining whether to apply a piggyback.

The present invention may be embodied in other specific forms without departing from its spirit or essential characteristics. In the described embodiment, a piggyback is applied in a PCF mode in wireless LAN communications. However, it will be readily apparent to those skilled in the art that it is also possible to apply the piggyback in wireless LAN communications using a DCF mode by defining the type of a frame for applying the piggyback in the DCF mode. Although in the foregoing description, AP and stations have determined whether to apply the piggyback to transmit frames, they may also be able to transmit information necessary to help other stations to determine whether to apply a piggyback. The information includes information about whether the AP and the stations have adopted the piggyback, frames to be transmitted, and channel status.

According to the invention, it is possible to increase data throughput by adaptively determining whether to apply a piggyback according to the status of a communication environment in wireless LAN communications and by transmitting a frame according to the result of the determination. To achieve the purpose, the invention provides a mechanism that can operate without revising a conventional standard specification.

The aforementioned embodiments are merely illustrative in every respect and should not be considered restrictive in any way. The scope of the invention is given by the appended claims, rather than the preceding description, and all variations and equivalents which fall within the range of the claims are intended to be embraced therein.

1. A wireless local area network (LAN) communication method, comprising:
adaptively determining whether or not to apply a piggyback according to a communication environment; and
transmitting a frame containing two or more kinds of information according to a result of the determination.

2. The method of claim 1, wherein the determination is performed based on information about a target station to which the frame is to be sent.

3. The method of claim 2, wherein the information about the target station contains information about whether the frame is being successively sent to the same target station.

4. The method of claim 1, wherein the determination is performed based on information about characteristics of data to be transmitted.

5. The method of claim 4, wherein the information about the characteristics of data to be transmitted contains information about whether a size of a frame is less than a predetermined threshold.

6. The method of claim 1, wherein the determination is performed based on information about channel status.

7. The method of claim 6, wherein the information about the channel status contains information about whether a frame loss rate is less than a predetermined threshold.

8. The method of claim 6, wherein the information about channel status contains information about whether a derived received signal strength indication (RSSI) is greater than a second predetermined threshold.

9. The method of claim 1, wherein the frame containing two or more kinds of information includes one of data+poll, data+ACK, data+poll+ACK, and poll+ACK frames.

10. The method of claim 1, wherein transmission is performed in a Point Coordination Function (PCF) mode.

11. A recording medium on which is recorded a program for performing a wireless local area network (LAN) communication method, said method comprising:
adaptively determining whether or not to apply a piggyback according to a communication environment; and
transmitting a frame containing two or more kinds of information according to a result of the determination.

12. The recording medium according to claim 11, wherein the determination is performed based on information about a target station to which the frame is to be sent.

13. The recording medium according to claim 12, wherein the information about the target station contains information about whether the frame is being successively sent to the same target station.

14. The recording medium according to claim 11, wherein the determination is performed based on information about characteristics of data to be transmitted.

15. The recording medium according to claim 14, wherein the information about the characteristics of data to be transmitted contains information about whether a size of a frame is less than a predetermined threshold.

16. The recording medium according to claim 11, wherein the determination is performed based on information about channel status.

17. The recording medium according to claim 16, wherein the information about the channel status contains information about whether a frame loss rate is less than a predetermined threshold.

18. The recording medium according to claim 16, wherein the information about channel status contains information about whether a derived received signal strength indication (RSSI) is greater than a second predetermined threshold.

19. The recording medium according to claim 11, wherein the frame containing two or more kinds of information includes one of data+poll, data+ACK, data+poll+ACK, and poll+ACK frames.

20. The recording medium according to claim 11, wherein transmission is performed in a Point Coordination Function (PCF) mode.
